(19) United States
(12) Patent Application Publication
(10) Pub. No.: US 2022/0101341 A1
(43) Pub. Date: Mar. 31, 2022

(54) ENTITY INFORMATION ENRICHMENT FOR COMPANY DETERMINATIONS

(71) Applicant: International Business Machines Corporation, Armonk, NY (US)

(72) Inventors: Jeong Won An, Markham (CA); Alvin Kinwai Cho, San Jose, CA (US); David D'Costa, Toronto (CA); J. Thomas Eck, Wall Township, NJ (US); Sridhar Mooghala, Morrisville, NC (US); Jessica G. Snyder, Arlington, MA (US); Robert Stanich, Montauk, NY (US); David Xie, Scarborough (CA); Nikhila Nandgopal, Brooklyn, NY (US); Matthew Cote, York (CA); Joseph Sean Eugene Tiley, Mississauga (CA)

(21) Appl. No.: 17/037,816

(22) Filed: Sep. 30, 2020

(51) Int. Cl. G06Q 30/00; G06F 16/903; G06N 20/00; G06N 7/00

(52) U.S. Cl. CPC G06Q 30/0185; G06N 7/005; G06N 20/00; G06F 16/90335

(57) ABSTRACT

A system, computer program product, and method are presented for determining illegitimate business entities, and, more specifically, to distinguishing between legitimate business entities and illegitimate business entities. The method includes identifying a target entity using known attributes of the target entity and collecting, from one or more external sources, additional attributes of the target entity. The method also includes injecting the known attributes and the additional attributes into one or more models including at least one of one or more machine learning models and one or more statistical models. The method further includes generating, through the one or more machine learning models, one or more scores that indicate a probability that the target entity is an illegitimate business.

### BACKGROUND

The present disclosure relates to determining business credentials and practices of business entities, and, more specifically, to distinguishing certain business credentials and practices between business entities.

Many known business entities, including those business entities referred to as “shell companies” or “shell corporations,” are legitimate. However, at least some known business entities, whether a shell corporation or not, may have dubious credentials with respect to their legitimacy as a business entity. Features of business entities that may be suspicious include dubious business credentials and practices, no physical address, possible mailing addresses, inconsistent physical addresses, and little to no evidence of discernable economic value. Shell corporations have the additional feature of facilitating the masking of the actual identities of the individuals and/or business entities that are storing their assets therein, thereby evading scrutiny. In some known instances, it is often prohibitively difficult, time-consuming, and resource-consuming to unwind the true relationships among the respective individuals and the business entities.

### SUMMARY

A system, computer program product, and method are provided for determining illegitimate business entities.

In one aspect, a computer system is provided for determining illegitimate business entities. The system includes one or more processing devices and at least one memory device operably coupled to the one or more processing device. The one or more processing devices are configured to identify a target entity using known attributes of the target entity and collect, from one or more external sources, additional attributes of the target entity. The one or more processing devices are also configured to inject the known attributes and the additional attributes into one or more models including at least one of one or more machine learning models and one or more statistical models. The one or more processing devices are further configured to generate, through the one or more models, one or more scores that indicate a probability that the target entity is an illegitimate business.

In another aspect, a computer program product is provided for determining illegitimate business entities. The computer program product includes one or more computer readable storage media, and program instructions collectively stored on the one or more computer storage media. The product also includes program instructions to identify a target entity using known attributes of the target entity and to collect, from one or more external sources, additional attributes of the target entity. The product also includes program instructions to inject the known attributes and the additional attributes into one or more into one or more models including at least one of one or more machine learning models and one or more statistical models. The product also includes program instructions to generate, through the one or more models, one or more scores that indicate a probability that the target entity is an illegitimate business.

In yet another aspect, a computer-implemented method is provided for determining illegitimate business entities, and, more specifically, to distinguishing between legitimate business entities and illegitimate business entities. The method includes identifying a target entity using known attributes of the target entity and collecting, from one or more external sources, additional attributes of the target entity. The method also includes injecting the known attributes and the additional attributes into one or more models including at least one of one or more machine learning models and one or more statistical models. The method further includes generating, through the one or more models, one or more scores that indicate a probability that the target entity is an illegitimate business.

The present Summary is not intended to illustrate each aspect of, every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1 is a schematic diagram illustrating a cloud computer environment, in accordance with some embodiments of the present disclosure.

FIG. 2 is a block diagram illustrating a set of functional abstraction model layers provided by the cloud computing environment, in accordance with some embodiments of the present disclosure.

FIG. 3 is a block diagram illustrating a computer system/server that may be used as a cloud-based support system, to implement the processes described herein, in accordance with some embodiments of the present disclosure.

FIG. 4 is a schematic diagram illustrating a system to determine illegitimate business entities, in accordance with some embodiments of the present disclosure.

FIG. 5 is a flowchart illustrating a process for training one or more machine learning models and statistical models to determine illegitimate business entities, in accordance with some embodiments of the present disclosure.

FIG. 6 is a flowchart illustrating a process for scoring target entities to determine illegitimate business entities, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments. In addition, it will be appreciated that, although specific embodiments have been described herein for purposes of illustration, various modifications may be made without departing from the spirit and scope of the embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows.

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows.

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

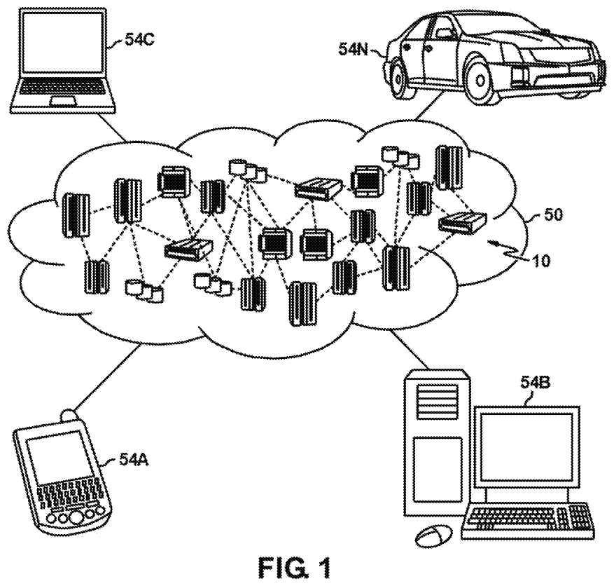

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

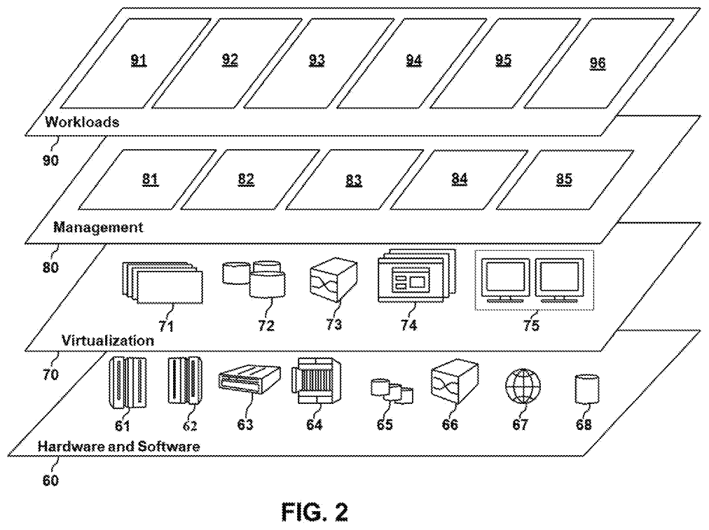

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and determining illegitimate business entities 96.

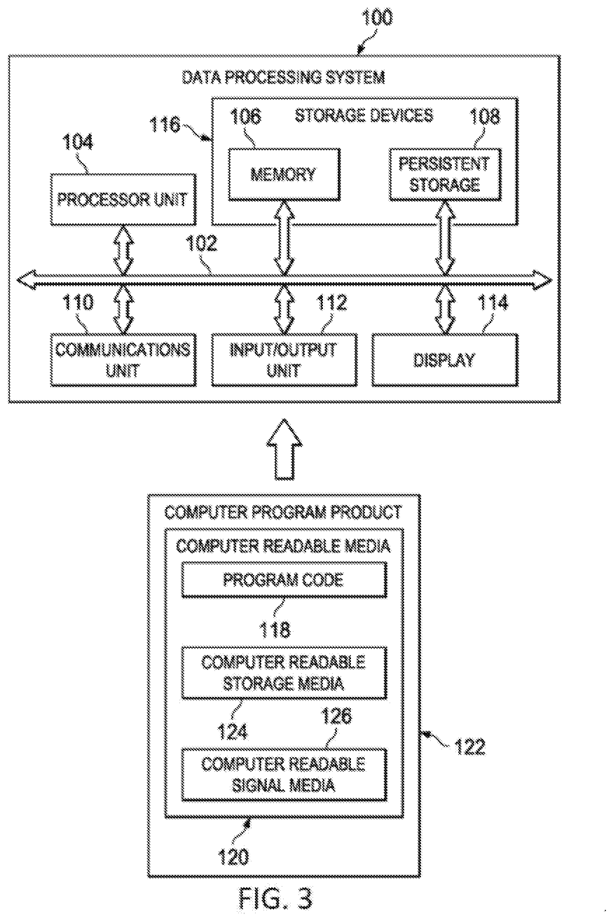

Referring to FIG. 3, a block diagram of an example data processing system, hereon referred to as computer system 100 is provided. System 100 may be embodied in a computer system/server in a single location, or in at least one embodiment, may be configured in a cloud-based system sharing computing resources. For example, and without limitation, the computer system 100 may be used as a cloud computing node 10.

Aspects of the computer system 100 may be embodied in a computer system/server in a single location, or in at least one embodiment, may be configured in a cloud-based system sharing computing resources as a cloud-based support system, to implement the system, tools, and processes described herein. The computer system 100 is operational with numerous other general purpose or special purpose computer system environments or configurations. Examples of well-known computer systems, environments, and/or configurations that may be suitable for use with the computer system 100 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

The computer system 100 may be described in the general context of computer system-executable instructions, such as program modules, being executed by the computer system 100. Generally, program modules may include routines, programs, objects, components, logic, data structures, and so on that perform particular tasks or implement particular abstract data types. The computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, the computer system 100 is shown in the form of a general-purpose computing device. The components of the computer system 100 may include, but are not limited to, one or more processors or processing devices 104 (sometimes referred to as processors and processing units), e.g., hardware processors, a system memory 106 (sometimes referred to as one or more memory devices), and a communications bus 102 that couples various system components including the system memory 106 to the processing device 104. The communications bus 102 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The computer system 100 typically includes a variety of computer system readable media. Such media may be any available media that is accessible by the computer system 100 and it includes both volatile and non-volatile media, removable and non-removable media. In addition, the computer system 100 may include one or more persistent storage devices 108, communications units 110, input/output (I/O) units 112, and displays 114.

The processing device 104 serves to execute instructions for software that may be loaded into the system memory 106. The processing device 104 may be a number of processors, a multi-core processor, or some other type of processor, depending on the particular implementation. A number, as used herein with reference to an item, means one or more items. Further, the processing device 104 may be implemented using a number of heterogeneous processor systems in which a main processor is present with secondary processors on a single chip. As another illustrative example, the processing device 104 may be a symmetric multiprocessor system containing multiple processors of the same type.

The system memory 106 and persistent storage 108 are examples of storage devices 116. A storage device may be any piece of hardware that is capable of storing information, such as, for example without limitation, data, program code in functional form, and/or other suitable information either on a temporary basis and/or a permanent basis. The system memory 106, in these examples, may be, for example, a random access memory or any other suitable volatile or non-volatile storage device. The system memory 106 can include computer system readable media in the form of volatile memory, such as random access memory (RAM) and/or cache memory.

The persistent storage 108 may take various forms depending on the particular implementation. For example, the persistent storage 108 may contain one or more components or devices. For example, and without limitation, the persistent storage 108 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the communication bus 102 by one or more data media interfaces.

The communications unit 110 in these examples may provide for communications with other computer systems or devices. In these examples, the communications unit 110 is a network interface card. The communications unit 110 may provide communications through the use of either or both physical and wireless communications links.

The input/output unit 112 may allow for input and output of data with other devices that may be connected to the computer system 100. For example, the input/output unit 112 may provide a connection for user input through a keyboard, a mouse, and/or some other suitable input device. Further, the input/output unit 112 may send output to a printer. The display 114 may provide a mechanism to display information to a user. Examples of the input/output units 112 that facilitate establishing communications between a variety of devices within the computer system 100 include, without limitation, network cards, modems, and input/output interface cards. In addition, the computer system 100 can communicate with one or more networks such as a local area network (LAN), a general wide area network (WAN), and/or a public network (e.g., the Internet) via a network adapter (not shown in FIG. 3). It should be understood that although not shown, other hardware and/or software components could be used in conjunction with the computer system 100. Examples of such components include, but are not limited to: microcode, device drivers, redundant processing units, external disk drive arrays, RAID systems, tape drives, and data archival storage systems.

Instructions for the operating system, applications and/or programs may be located in the storage devices 116, which are in communication with the processing device 104 through the communications bus 102. In these illustrative examples, the instructions are in a functional form on the persistent storage 108. These instructions may be loaded into the system memory 106 for execution by the processing device 104. The processes of the different embodiments may be performed by the processing device 104 using computer implemented instructions, which may be located in a memory, such as the system memory 106. These instructions are referred to as program code, computer usable program code, or computer readable program code that may be read and executed by a processor in the processing device 104. The program code in the different embodiments may be embodied on different physical or tangible computer readable media, such as the system memory 106 or the persistent storage 108.

The program code 118 may be located in a functional form on the computer readable media 120 that is selectively removable and may be loaded onto or transferred to the computer system 100 for execution by the processing device 104. The program code 118 and computer readable media 120 may form a computer program product 122 in these examples. In one example, the computer readable media 120 may be computer readable storage media 124 or computer readable signal media 126. Computer readable storage media 124 may include, for example, an optical or magnetic disk that is inserted or placed into a drive or other device that is part of the persistent storage 108 for transfer onto a storage device, such as a hard drive, that is part of the persistent storage 108. The computer readable storage media 124 also may take the form of a persistent storage, such as a hard drive, a thumb drive, or a flash memory, that is connected to the computer system 100. In some instances, the computer readable storage media 124 may not be removable from the computer system 100.

Alternatively, the program code 118 may be transferred to the computer system 100 using the computer readable signal media 126. The computer readable signal media 126 may be, for example, a propagated data signal containing the program code 118. For example, the computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 118 may be downloaded over a network to the persistent storage 108 from another device or computer system through the computer readable signal media 126 for use within the computer system 100. For instance, program code stored in a computer readable storage medium in a server computer system may be downloaded over a network from the server to the computer system 100. The computer system providing the program code 118 may be a server computer, a client computer, or some other device capable of storing and transmitting the program code 118.

The program code 118 may include one or more program modules (not shown in FIG. 3) that may be stored in system memory 106 by way of example, and not limitation, as well as an operating system, one or more application programs, other program modules, and program data. Each of the operating systems, one or more application programs, other program modules, and program data or some combination thereof, may include an implementation of a networking environment. The program modules of the program code 118 generally carry out the functions and/or methodologies of embodiments as described herein.

The different components illustrated for the computer system 100 are not meant to provide architectural limitations to the manner in which different embodiments may be implemented. The different illustrative embodiments may be implemented in a computer system including components in addition to or in place of those illustrated for the computer system 100.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many known business entities, including those business entities referred to as “shell companies” or “shell corporations,” are legitimate. A shell company may be a non-publicly traded corporation, or a limited-liability company (LLC) that is typically configured to manage assets of the actual owners, sometimes physical and sometimes monetary, for legitimate business reasons, e.g., security of the assets. However, at least some known business entities, whether a shell corporation or not, may have dubious credentials and practices with respect to their legitimacy as a business entity. Features of business entities that may be illegitimate include no physical address, possible mailing addresses, inconsistent physical addresses, and little to no evidence of discernable economic value. Shell corporations have the additional feature of facilitating the masking of the actual identities of the individuals and/or business entities that are storing their assets therein, thereby evading scrutiny. Typically, such illegitimate business entities include features that may tend to obscure the true purposes of the business, the associated persons, beneficial ownership, and corporate structure. In some known instances, it is often prohibitively difficult, time-consuming, and resource-consuming to unwind the true relationships among the respective individuals and the business entities. Many such known illegitimate business entities operating as shell companies typically employ accounting and/or legal professionals to further shield the respective shell corporations, thereby providing further obfuscation. Such illegitimate businesses may provide opportunities for illicit activities, i.e., deceitful business practices including fraud, money laundering, tax evasion, terrorist financing, sanctions violations, insider trading, bribery, trafficking, and other financial crimes.

A system, computer program product, and method are disclosed and described herein directed toward determining illegitimate business entities, and, more specifically, to distinguishing between legitimate business entities and illegitimate business entities. In at least some embodiments, the system, computer program product, and method are implemented to determine the likeliness of a target business entity to be a legitimate business by first utilizing known attributes such as the legal name and address to identify the target business entity. These known attributes of the target business entity are enriched with additional associated attributes and information from one or more external data sources. Using statistical and machine-learning analytics to produce probability scores directed toward whether the target business entity is legitimate or illegitimate. In addition, in some embodiments, the analytics may provide other insights into the target business entity such as exonerating and aggravating factors associated with the scoring.

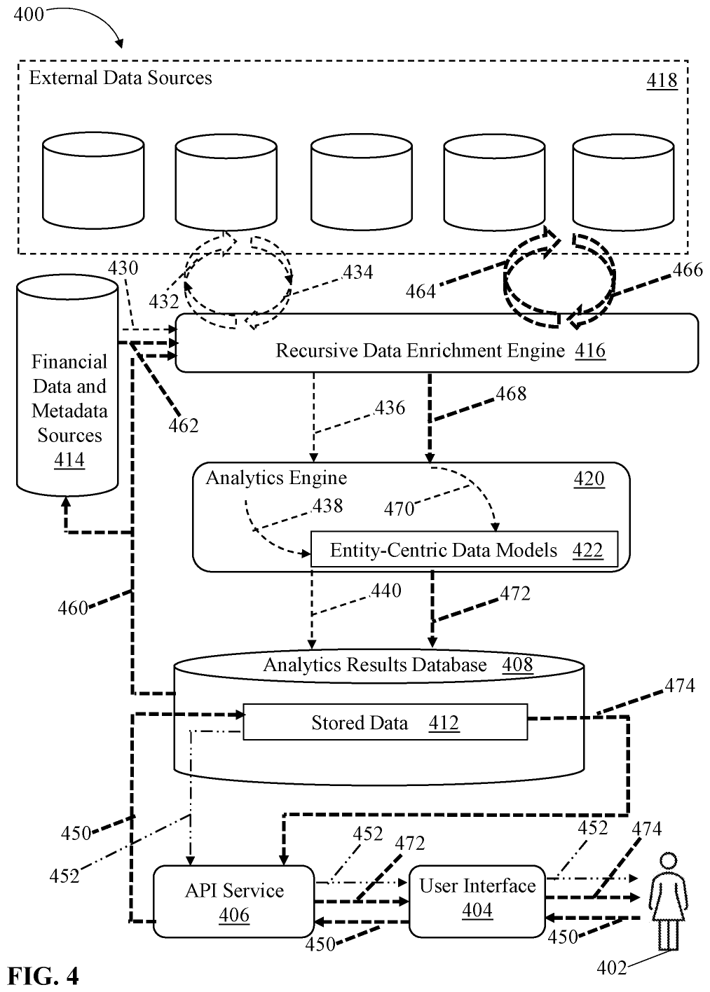

Referring to FIG. 4, a schematic diagram is provided illustrating an business entity determination system 400 to determine illegitimate, and legitimate, business entities. Also referring to FIG. 3, a user 402 interfaces with the business entity determination system 400 through a user interface 404 that is configured to facilitate the user 402 inputting a query with respect to one or more target business entities and receiving a response to the query. In at least some embodiments, the business entity determination system 400 includes an application programing interface (API) service 406 operably and communicatively coupled to the user interface 404. The API service 406 may be any intermediary software computing interface which defines interactions between any two other software applications. The API service 406 facilitates the interface between the user 402 and the components of the business entity determination system 400. In some embodiments, the API service 406 may be resident within the memory 106. The business entity determination system 400 also includes an analytics results database 408, that in some embodiments, may be resident within one or more of the memory 106 and the persistent storage 108. The analytics results database 408 is communicatively coupled with the API service 406. In at least some embodiments, the analytics results database 408 includes the associated stored data 412 therein, where the associated stored data 412 is discussed further herein. The stored data 412 is communicatively coupled to the user interface 404 through the API service 406. The analytics results database 408 is communicatively coupled to one or more processing devices, e.g., the processing device 104.

In one or more embodiments, the analytics results database 408 is communicatively coupled to a database that includes data from one or more financial data and metadata sources 414. In at least some embodiments, the financial data and metadata sources 414 are located in a decentralized manner in any number of locations available through the Internet, and the data collected therefrom (discussed further herein) is stored in the stored data 412. In some embodiments, the financial data and metadata sources 414 include data are stored in a centralized manner, for example, on a government or a financial services database readily accessible by the user 402 through the business entity determination system 400. The business entity determination system 400 further includes a recursive data enrichment engine 416 communicatively coupled to the analytics results database 408 and the financial data and metadata sources 414. In some embodiments, the recursive data enrichment engine 416 is a software-based artifact resident in the system memory 106. The recursive data enrichment engine 416 is configured to gather additional information and attributes associated with the respective target business entity that is the subject of the user's query, through recursively drilling down through external data to a predetermined depth to further improve the accuracy of machine learning and statistical models (both discussed further herein).

In at least some embodiments, the recursive data enrichment engine 416 is communicatively coupled to a plurality of external data sources 418. In at least some embodiments, the external data sources 418 are located in a decentralized manner in any number of locations available through the Internet, and the data collected therefrom (discussed further herein) is stored in the stored data 412. In some embodiments, the external data sources 418 are stored in a centralized manner, for example, on a government or a financial services database readily accessible by the user 402 through the business entity determination system 400. Examples of the external data sources 418 include, without limitation, entities such as Dun and Bradstreet, the United States Patent and Trademark Office (USPTO), New York Stock Exchange (NYSE). In addition, examples of the external data sources 418 include, without limitation, the Panama Papers, Paradise Papers, Bahamas Leaks, and Offshore leaks database, that combined include identities of hundreds of thousands of offshore entities and individuals, and millions of financial transactions, many of which are considered problematic.

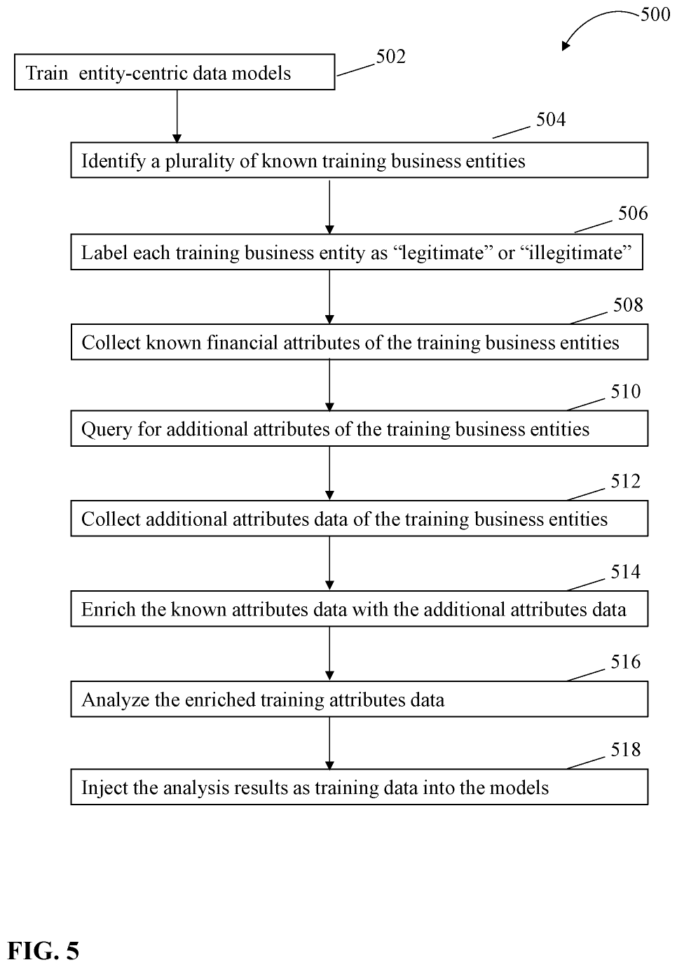

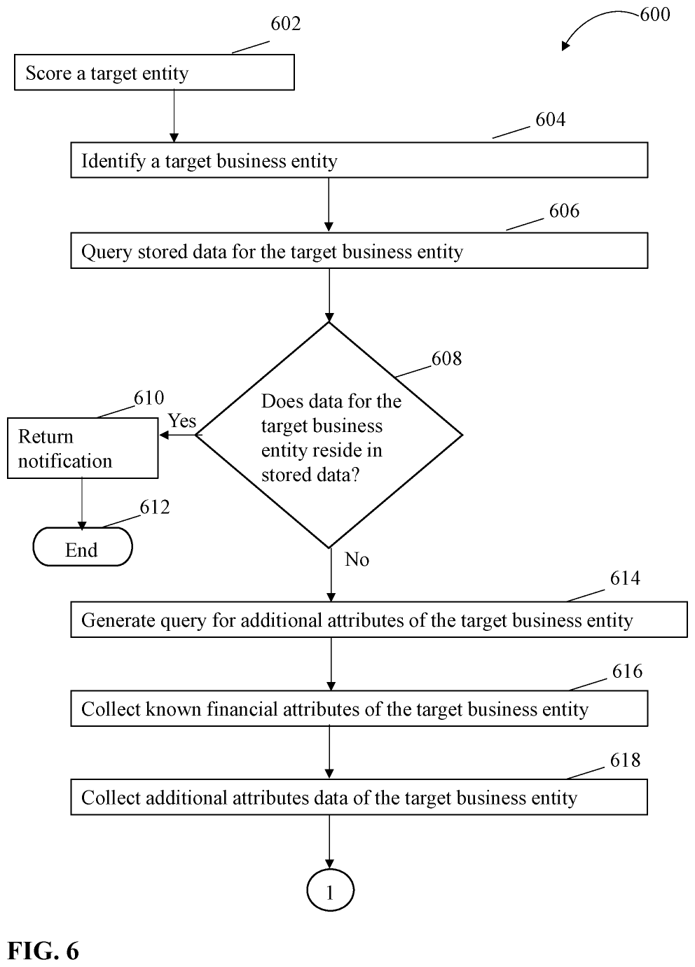

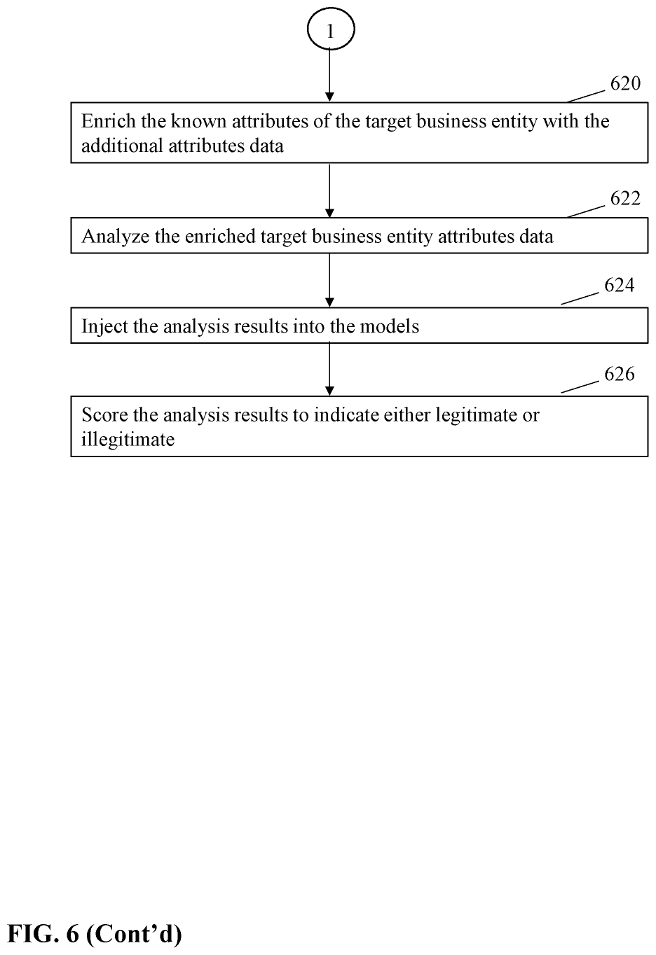

In one or more embodiments, the business entity determination system 400 includes an analytics engine 420 communicatively coupled to the recursive data enrichment engine 416 and the analytics results database 408. In some embodiments, the analytics engine 420 is a software-based artifact resident in the system memory 106. The analytics engine 420 is configured to include one or more trained entity-centric data models 422, where the models are machine learning (ML) models and statistical models that are applied to enriched data transmitted from the recursive data enrichment engine 416. The ML and statistical models may include several classes of models, e.g., without limitation, decision tree models, regression models, and artificial neural networks (ANN). The entity-centric data models 422 are further configured to search for patterns characteristic of illegitimate (and, legitimate) business entities, including, without limitation, shell corporations. The entity-centric data models 422 are trained using enriched historical financial data and metadata matched against known illegitimate business entities from the financial data and metadata sources 414 and external data sources 418 coupled to the recursive data enrichment engine 416. The influences of the entity-centric data models 422 on the final probability scoring values are weighted based on their prediction accuracy from the training data set (discussed further herein. The features of FIG. 4 are discussed further with respect to FIGS. 5 and 6.

Referring to FIG. 5, a flowchart is provided illustrating a process 500 for training 502 one or more machine learning models and statistical models to determine illegitimate business entities. Also referring to FIG. 4, the plurality of entity-centric data models 422 are trained 502 to use one or more of the features of machine learning models and one or more of the features of statistical models to generate labeled financial entity data and labeled associated financial data, including, without limitations, labeled financial transactions data to recognize legitimate and illegitimate business entities. In some embodiments, a plurality of both machine learning models and statistical models are used to take advantage of the benefits of each model to generate more refined, accurate, and precise predictions in an ensemble model configuration. In some embodiments, the respective predictive outputs of the models may indicate that only one model is necessary for the present analysis. Accordingly, a plurality of entity-centric data models 422 are trained 502 to implement an ensemble model configuration for the aforementioned predictive analyses.

In one or more embodiments, a plurality of known business entities are identified 504. Since the purpose of the training 502 is to generate models that can effectively discriminate between legitimate and illegitimate business entities, a plurality of known legitimate business entities and a plurality of illegitimate business entities are researched and used. In some embodiments, the user 402 selects at least a portion of the initial training business entities, where in some embodiments the initial training of the models may be sufficient to at least partially automate this portion of the training process 500. In some embodiments, initial attributes such as the legal name and address are discovered and are sufficient to identify 504 each respective training business entity. Each training business entity may be labeled 506 as either “legitimate” and “illegitimate” as appropriate. Once the training business entities are identified 504, known financial attributes of the training business entities are collected 508. Such known training financial attributes data and metadata 430, hereon referred to as known training attributes 430, for each of the training business entities is collected from the financial data and metadata sources 414. The known training attributes 430 includes, without limitation, one or more respective sets of financial transactions, where the respective known training attributes 430 are properly labeled, including, without limitation, inheriting the labels of “legitimate” and “illegitimate” from the respective training business entities. In some embodiments, one or more legal addresses and legal entity names may be ingested as metadata associated with the training financial transactions in the known training attributes 430.

In at least some embodiments, the known training attributes 430 are augmented through querying 510 the external data sources 418 for additional attributes data of the training business entities. In some embodiments, the respective queries 432 are generated based on the known training attributes 430. The additional attributes training data 434 is collected 512 from the external sources 418 and the additional attributes training data 434 are used to enrich 514 the known training attributes 430, thereby generating enriched training data 436. The data collection 512 from the external sources 418 is executed recursively through the recursive data enrichment engine 416, where, in some embodiments, the recursive nature of the collection operation 512 includes, without limitation, a recognized need for additional data based on the data previously collected. Such additional attributes training data 434 includes, without limitation:

relationships to one or more other entities (e.g., without limitation, parent or holding companies);

relationships to one or more individuals (e.g., without limitation, the size of the employee pool, stockholders and stakeholders);

relationships to one or more addresses (e.g., without limitation, no known physical addresses, or one or more inconsistent addresses, e.g., one or more other entities, business or resident, are indicated at that address, the address does not physically exist, the business is in a business sector that is not consistent with the associated zoning requirements for that geographical location, e.g., the business is a multi-national company and the address is located in a residential area);

records of financial transactions not already collected with the known training attributes 430 (e.g., without limitation, records of financial transactions through overseas accounts and shell corporations);

registration with one or more government bodies (e.g., without limitation, State of incorporation);

one or more issued certifications (e.g., without limitation, Women Owned Small Business (WOSB) and Women's Business Enterprise (WBE) Certifications, B Corp Certification, Veteran Owned Small Business (VOSB) and Service-Disabled Veteran-Owned Small Business (SDVOSB) Certifications, and Leadership in Energy and Environmental Design (LEED) Certification, where such certifications may provide some information as to the business and its alleged primary owners and employees);

one or more owned real property assets;

one or more intellectual property assets (e.g., patents, trademarks, and copyrights);

one or more associated websites;

one or more social media accounts;

public trading data;

government-issued watch list data (e.g., and without limitation, presence of the training business entities or any associated natural persons as registered on the Office of Foreign Assets Control (OFAC) list, and potentially subject to economic and trade sanctions; associated individuals that have been previously, or are currently under investigation for fraud); and

presence of mentions in one or more of, without limitation, the Panama Papers, Paradise Papers, Bahamas Leaks, and Offshore leaks database.

The generated enriched training data 436 is transmitted to the analytics engine 420 for analysis 516 of the enriched training data 436 through the statistical and machine learning analytical features embedded within the analytics engine 420, including, without limitation, the entity-centric data models 422. In some embodiments, the analytical features may be inherent within the various entity-centric data models 422, and in some embodiments, the analysis algorithms are in separate engines or modules (not shown). In addition, the results of the analysis operation 516 include generating analysis results training data 438 and injecting 518 the generated analysis results training data 438 into the respective, and appropriate, entity-centric data models 422. In some embodiments, supervised training with the analysis results training data 438 may be performed. The collected training data and any training outputs of the entity-centric data models 422 are transmitted as analytics engine output 440 to the stored data 412 in the analytics results database 408. Accordingly, the entity-centric data models 422 are trained to generate a score at least partially indicative of legitimate business entities and illegitimate business entities as a function of the algorithms established therein.

Referring to FIG. 6, a flowchart is provided illustrating a process 600 for scoring 602 target entities to determine illegitimate business entities. Also referring to FIG. 4, the user 402 may identify 604 a particular business entity as a suspected illegitimate business entity, or such a suspicion may be raised by the business entity determination system 400. In some embodiments, for the identification operation 604, the user 402 may discover some initial known attributes such as the legal name and address that may be sufficient to identify 604 a target business entity. The user 402 may query 606 the stored data 412 in the analytics results database 408 with an anticipation that the query 450 using the initial known attributes of the target business entity will return existing data on the target business entity. The user query 450 is entered through the user interface 404 and is transmitted to the stored data 412 through the API service 406. A determination 608 is made with respect to whether data for the target business entity is presently resident within the stored data 412. If the response is “Yes,” a notification 452 is returned 610 to the user 402 through the API service 406 and the user interface 404, the process 600 ends 612, and the user 402 may elect to query the stored data 412 further.

If the response to the determination operation 608 is “No,” the process 600 proceeds to further queries and analyses as described further. In one or more embodiments, the query 450 is transformed within the analytic results database 408 and transmitted therefrom as a query 460 generated 614 toward gathering information with respect to the attributes of the target business entity. In some embodiments, the user 402 is prompted to initiate the query 460 through the user interface 404. The query 460 is transmitted to the financial data and metadata sources 414 to search for and collect known financial attributes of the target business entity. The associated known target entity attributes 462 are collected 616 from the financial data and metadata sources 414. The known target entity attributes 462 include, without limitation, one or more respective sets of financial transactions associated with the target business entity. In some embodiments, one or more legal addresses and legal entity names may be ingested as metadata associated with the financial transactions in the known target entity attributes 462. The known target entity attributes 462 are transmitted to the recursive data enrichment engine 416. In some embodiments, the transmittal of the known target entity attributes 462 to the recursive data enrichment engine 416 is sufficient to invoke one or more queries of the 464 of the external data sources 418. In some embodiments, the query 460 is also transmitted to the recursive data enrichment engine 416 to initiate the one or more queries of the 464 of the external data sources 418. The recursive data enrichment engine 416 uses one or more recursive analysis techniques on one or more of the known target entity attributes 462. Since the data collection 618 of the target entity additional attributes 466 is recursive, the known target entity attributes 462 collection 616 from the financial data and metadata sources 414 and the target entity additional attributes 466 collection 618 may be executed in parallel. Also, the recursive analysis techniques may be executed on the retrieved target entity additional attributes 466. The target entity additional attributes 466 are similar to the additional attributes training data 434 as previously discussed. Accordingly, the known target entity attributes 462 are enriched 620 with the target entity additional attributes 466 to generate enriched target entity data 468.

In at least some embodiments, the enriched target entity data 468 is transmitted to the analytics engine 420, where the enriched target entity data 468 is analyzed 622 by the by the analysis features of the analytics engine, including the entity-centric data models 422. The analyses 622 of the enriched target entity data 468 may provide insights into the target business entity, such as exonerating and aggravating factors associated with the pending scoring. Examples of exonerating factors include, without limitation, consistent verification of address data, lack of identification on the previously identified, no association with the Panama Papers, etc., and a significant number of intellectual property assets, e.g., a number of issued patents. Examples of aggravating factors include, without limitation, indications that additional business entities or domiciled residents are using the same address; the address does not physically exist; the address is not geographically located in the appropriate location; e.g., an alleged multi-national company indicates an address located in a residential area, or the address indicates the property is used as a restaurant, but the target business entity is indicated as a financial institution; and any one individual found to have an association with the target business entity has been, or currently is, under investigation for fraud. The target entity analytic results 470 are transmitted to the entity-centric data models 422.

The target entity analytic results 470 are injected 624 into the entity-centric data models 422 for scoring 626 the target entity analytic results 470, where the target entity analytic results 470 are scored 626 against one or more of the entity-centric data models 422. The entity-centric data models 422 generates the score 472 to indicate a probability that the target business entity is either a legitimate business entity or an illegitimate business entity. The score 472 is transmitted to the stored data 412 with the enriched target entity data 468, including the exonerating and aggravating factors. The target entity score output 474 is transmitted from the analytics results database 408 to the user interface 404 through the API service 406. In some embodiments, the target entity score output 474 includes ranges such as, and without limitation, 0.0 to 0.25 is indicative of a legitimate business entity, 0.75 to 1.00 is indicative of an illegitimate business entity, and a range of 0.25 or 0.75 is indeterminant.

In one or more embodiments, the ensemble model configuration facilitates determining information associated with the influences each individual model exerts on the scores 472 based on the prediction accuracy with respect to the training data set, where each model may have particular idiosyncrasies due to the structure of the model.

The system, computer program product, and method as disclosed herein facilitate overcoming the disadvantages and limitations of manual determinations of whether a business entity is a shell corporation, and whether the business entity is legitimate of illegitimate through automation of the determination process. For example, the automated analysis techniques as described herein greatly accelerate the research, unwinding, and scoring processes and facilitate the accuracy and precision of the scoring, regardless of the level of obfuscation associated with the target business entity.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system comprising:
one or more processing devices and at least one memory device operably coupled to the one or more processing devices, the one or more processing devices are configured to:
identify a target entity using known attributes of the target entity;
collect, from one or more external sources, additional attributes of the target entity;
inject the known attributes and the additional attributes into one or more models including at least one of:
one or more machine learning models; and
one or more statistical models; and
generate, through the one or more models, one or more scores that indicate a probability that the target entity is an illegitimate business.

2. The system of claim 1, wherein the one or more processing devices are further configured to:
enrich the known attributes with the additional attributes, thereby generating enriched target entity data.

3. The system of claim 2, wherein the one or more processing devices are further configured to:
use one or more recursive analysis techniques on one or more of the known attributes and the additional attributes.

4. The system of claim 1, wherein the one or more processing devices are further configured to:
generate, within a database, a query directed toward the target entity; and
not locate the target entity in the database.

5. The system of claim 1, wherein the one or more processing devices are further configured to:
discover at least one legal name and at least one address to identify the target entity.

6. The system of claim 1, wherein the one or more processing devices are further configured to:
use one or more recursive analysis techniques on the one or more of the known attributes and the additional attributes; and
generate, subject to the one or more recursive analyses, additional information with respect to the target entity.

7. The system of claim 1, wherein the one or more processing devices are further configured to:
train the one or more models comprising:
identify a plurality of known business entities;
collect known attributes of the plurality of business entities;
query the one or more external sources for additional attributes of the known business entities;
collect, from the one or more external sources, the additional attributes of the known business entities;
enrich the known attributes with the additional attributes, thereby generating enriched training data;
analyze the enriched training data, thereby generating analysis results training data; and
inject the analysis results training data into the one or more models, wherein the one or more models are trained to generate a score at least partially indicative of legitimate business entities and illegitimate business entities.

8. A computer program product, comprising:
one or more computer readable storage media; and
program instructions collectively stored on the one or more computer storage media, the program instructions comprising:
program instructions to identify a target entity using known attributes of the target entity;
program instructions to collect, from one or more external sources, additional attributes of the target entity;
program instructions to inject the known attributes and the additional attributes into one or more models including at least one of:
one or more machine learning models; and
one or more statistical models; and
program instructions to generate, through the one or more models, one or more scores that indicate a probability that the target entity is an illegitimate business.

9. The computer program product of claim 8, further comprising:
program instructions to enrich the known attributes with the additional attributes, thereby generating enriched target entity data; and
program instructions to use one or more recursive analysis techniques on one or more of the known attributes and the additional attributes.

10. The computer program product of claim 8, further comprising:
program instructions to generate, within a database, a query directed toward the target entity;
program instructions to not locate the target entity in the database; and
program instructions to discover at least one legal name and at least one address to identify the target entity.

11. The computer program product of claim 8, further comprising:
program instructions to use one or more recursive analysis techniques on the one or more of the known attributes and the additional attributes; and
program instructions to generate, subject to the one or more recursive analyses, additional information with respect to the target entity.

12. The computer program product of claim 11, further comprising:
program instructions to train the one or more models comprising:
program instructions to identify a plurality of known business entities;
program instructions to collect known attributes of the plurality of business entities;
program instructions to query the one or more external sources for additional attributes of the known business entities;
program instructions to collect, from the one or more external sources, the additional attributes of the known business entities;
program instructions to enrich the known attributes with the additional attributes, thereby generating enriched training data;
program instructions to analyze the enriched training data, thereby generating analysis results training data; and
program instructions to inject the analysis results training data into the one or more models, wherein the one or more models are trained to generate a score at least partially indicative of legitimate business entities and illegitimate business entities.

13. A computer-implemented method comprising:
identifying a target entity using known attributes of the target entity;
collecting, from one or more external sources, additional attributes of the target entity;
injecting the known attributes and the additional attributes into one or more models including at least one of:
one or more machine learning models; and
one or more statistical models; and
generating, through the one or more models, one or more scores that indicate a probability that the target entity is an illegitimate business.

14. The method of claim 13, further comprising:
enriching the known attributes with the additional attributes, thereby generating enriched target entity data.

15. The method of claim 14, wherein generating enriched target entity data further comprises:
using one or more recursive analysis techniques on one or more of the known attributes and the additional attributes.

16. The method of claim 13, wherein identifying the target entity comprises:
generating, within a database, a query directed toward the target entity; and
not locating the target entity in the database.

17. The method of claim 13, wherein identifying the target entity using known attributes of the target entity comprises:
discovering at least one legal name and at least one address to identify the target entity.

18. The method of claim 13, wherein collecting, from the one or more external sources, the additional attributes of the target entity comprises:
gathering information, with respect to the target entity, directed toward one or more of:
relationships to one or more other entities;
relationships to one or more individuals;
relationships to one or more addresses;
records of financial transactions;
registration with one or more government bodies;
one or more issued certifications;
one or more owned real property assets;
one or more intellectual property assets;
one or more associated websites;
one or more social media accounts;
public trading data; and
government-issued watch list data.

19. The method of claim 18, further comprising:
using one or more recursive analysis techniques on the one or more of the known attributes and the additional attributes; and
generating, subject to the one or more recursive analyses, additional information with respect to the target entity.

20. The method of claim 13, further comprising:
training the one or more models comprising:
identifying a plurality of known business entities;
collecting known attributes of the plurality of business entities;
querying the one or more external sources for additional attributes of the known business entities;
collecting, from the one or more external sources, the additional attributes of the known business entities;
enriching the known attributes with the additional attributes, thereby generating enriched training data;
analyzing the enriched training data, thereby generating analysis results training data; and
injecting the analysis results training data into the one or more models, wherein the one or more models are trained to generate a score at least partially indicative of legitimate business entities and illegitimate business entities.
